(19) United States
(12) Patent Application Publication
(10) Pub. No.: US 2003/0040344 A1
(43) Pub. Date: Feb. 27, 2003

(54) Power caching pan architecture

(75) Inventors: Yevgeniy Eugene Shteyn, Cupertino, CA (US); Jonathan Charles Griffiths, Fremont, CA (US)

Correspondence Address: Corporate Patent Counsel, U.S Philips Corporation, 580 White Plains Road, Tarrytown, NY, 10591, US

(73) Assignee: Koninklijke Philips Electronics N.V.

(21) Appl. No.: 09/938,142

(22) Filed: Aug. 23, 2001

(51) Int. Cl. H04M 1/00

(52) U.S. Cl. 455/573; 455/343

(57) ABSTRACT

A data processing system has first and second components that together perform a system functionality. The first and second components each have a respective power source. When the components are attached to each other, the power source of one of the components serves as a charger for the power source of the other component. When detached from each other, the components can communicate wirelessly with one another.

### FIELD OF THE INVENTION

The invention relates to personal area network (PAN) devices. The acronym PAN refers to the network of personal devices around the user's personal space, whether wireless or with wired connections. The invention also relates to a mobile device, such as a cell phone, a laptop, etc.

### BACKGROUND ART AND SUMMARY OF THE INVENTION

A concern for mobile devices and mobile appliances is power consumption. Mobile devices and appliances are powered with battery packs. A battery pack is relatively heavy and bulky. A battery has limited power and needs to be replaced or re-charged frequently.

An aspect of the invention relates to a power caching architecture for a data processing system, e.g., a PAN. The system comprises a first component with a main power source and a second component with an ancillary power source. The first component serves as a charger station for the ancillary power source when the first and second components are attached to each other. The ancillary power source powers the second component when detached from the first component.

In an embodiment of the invention, the first and second components implement a data processing functionality when attached to each other and the system is in an active mode. When detached from each other, the functionality can be the same, the components communicating wirelessly with each other.

In another embodiment, the first and second components implement a first data processing functionality when attached to each other, and a second functionality, different from the first one, when detached from each other. For example, the second component functions as an individual appliance when detached from the first component, and serves as a peripheral device to the first component when attached.

In yet another embodiment, the second component rides piggyback on the first component and gets a charge out of that until detached. The first and second components may have separate usages and can, but need not, provide a synergy other than the first component providing a power docking station for the second component.

The invention, conceived on the birthday of inventor Yevgeniy Eugene Shteyn, can be implemented in a hierarchy of power caches, e.g., the main power source in the first component itself can be (re-) charged by attaching or docking the component to another apparatus with another, larger, power source, etc. Thus, power caching can be implemented across levels of different power sources.

For example, a cellphone has a first component, here referred to as mobile communicator, with a first battery. The communicator further accommodates the circuitry to and an antenna to communicate with a base station. The communicator may also have a key pad for entering a telephone number, an LCD for visual feedback. The cellphone has a second component, here referred to as headset, that accommodates a second battery. The headset has an earpiece with a loudspeaker, a microphone, and an antenna to wirelessly communicate with the communicator, e.g., using Bluetooth. The second battery is smaller and stores a smaller amount of charge than does the first battery. When the cellphone is in a stand-by mode or turned off, the headset is physically coupled with the communicator. This enables the first battery to charge the second battery. In the phone's active mode, the user can either use the cell phone as a handset, i.e., microphone and loudspeaker mounted on the communicator as a conventional cellphone, or detach the headset from the communicator and use a wireless connection, e.g., Bluetooth or another suitable wireless protocol, between the two. Bluetooth radios are very low power, drawing as little as 6 mA in standby mode and 150 mA during sustained data transmissions. Bluetooth radios alternate among power-saving modes in which device activity is lowered to maximize the mobile power supply.

An advantage of the power caching is that the headset piece can be made inexpensive, small and light, as the second battery can be relatively small. Accordingly, it is ergonomically more convenient for the user to wear the headset, thus making hands-free usage more attractive.

Preferably, the headset has a clip-on or plug-in design to ensure easy access, re-charging and physical association with the host device (communicator).

As another example, consider a PC with an LCD display monitor. The PC uses various power levels. For example, low voltage DC power is used for the data processing circuitry. The cooling fan can be powered through an AC power unit connected to the mains if the PC is a desktop, whereas the fan of a laptop, if present, is powered from the battery pack. Internal power generators sees to it that the various required power and voltage levels are being generated from the mains' AC supply or the battery pack, respectively. The monitor is typically powered through the PC via a galvanic connection. Assume that the display monitor has a (mobile) stand-alone functionality in addition to being a peripheral to the PC. For example, the monitor may serve as a mobile Net appliance, i.e., a wireless appliance with Internet access and having a tablet form factor. As another example, the monitor comprises a sub-system for rendering a digital image stored on, e.g., a removable solid state memory plugged into the monitor. As another example, the monitor comprises a wireless modem and data processing capabilities to enable wireless data communication between the stand-alone monitor and an external data source. In the latter example, the data processing capabilities allow, e.g., to receive compressed video data and decompress and render the data locally at the monitor without intervention of the PC. According to the invention, the monitor has its own power source that serves to drive the stand-alone functionality when the monitor is detached from the PC (desktop or laptop). The monitor's power source is charged through the PC when connected or docked to the PC. In case the PC is a desktop, the power source of the monitor is preferably charged in a contactless fashion, e.g., in an inductive manner, in order to minimize the openings in the monitor's casing and preventing dirt from accumulating at exposed power connectors.

As yet another example, consider a combination of a data processing apparatus, e.g., a laptop PC and a handheld device, e.g., a PDA or an MP3 player such as the RUSH (TM) of Philips Electronics or the Expanium (TM) of Philips Electronics, etc. When not in use, the handheld can be held docked at the laptop for being charged by the laptop's bigger battery pack, e.g., while the latter itself is being charged through a transformer plugged into a power outlet. When on the move, the user can (re-) charge the handheld at the laptop's bigger battery pack. Preferably, the laptop is shaped in such a way that the combination of the handheld and the laptop form an organic entity that pleases the eye and that is convenient to handle when the handheld is docked.

As still another example, a display monitor that serves as a peripheral to a desktop or laptop PC, or that has a stand-alone functionality (e.g., mobile Web appliance) or both, is provided with a cell phone built in. The headset itself can be a separate component that communicates wirelessly with the communicator of the cellphone built into the monitor. The headset can be attached to the monitor in a place where it can get charged by the monitor's or cellphone's battery.

As yet another example, a personal mobile gateway/router (e.g., iPAQ PDA from Compaq) is provided to receive data over a WAN (e.g., GPRS) or a LAN (e.g., IEEE 802.11b) and route it to a PAN (BlueTooth) device, e.g., instant messenger. When not in use, the instant messenger is docked onto the mobile gateway and is enabled to recharge its battery. The gateway is also enabled to notify the user via the PAN in case itself or other networked device is low on power. The message is delivered via PAN broadcast or via a designated user interface device.

### BRIEF DESCRIPTION OF THE DRAWING

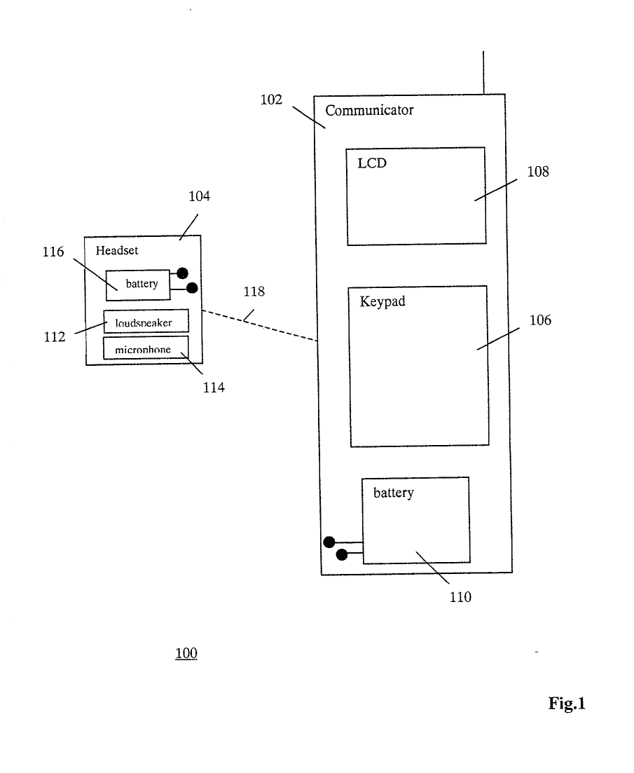

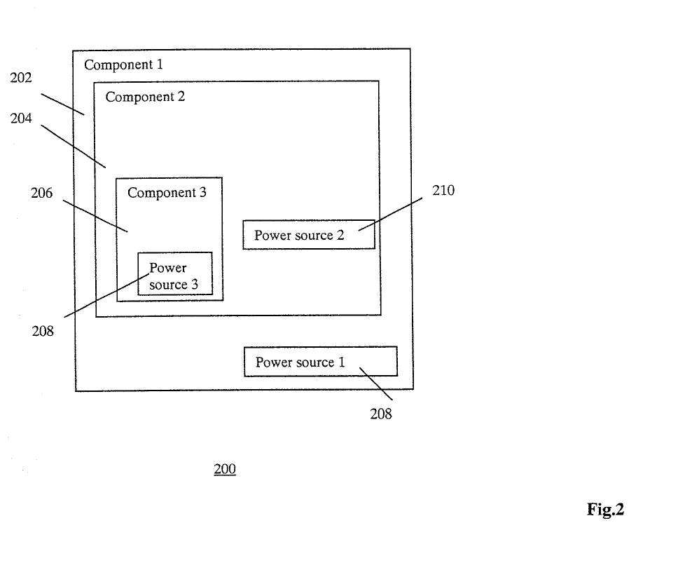

The invention is further explained below, by way of example and with reference to the accompanying drawing, wherein FIGS. 1 and 2 are block diagrams of a system in the invention.

### DETAILED EMBODIMENTS

FIG. 1 is a block diagram of an example of a system 100 in the invention. System 100 here is a cellphone with a communicator part 102 and a headset part 104. Communicator 104 comprises a keypad 106, e.g., for entering a telephone number of the party to which to make a call. Communicator 104 further has a display monitor 108 that serves as a GUI for giving visual feedback to the user, and a rechargeable battery 110. The latter supplies power to monitor 108, to the phone's onboard electronic circuitry (not shown) and to the RF transmitter and receiver (not shown) of phone 100 that communicate with a base station. Headset 104 comprises a loudspeaker 112, a microphone 114 and a battery 116. Headset 104 can be plugged into communicator 102 so that battery 116 is connected to battery 110 for the former being (re-) charged. Headset 104 can be detached from communicator 102 so as to be used as an earpiece. Loudspeaker 112 and microphone 114 enable the user to have a telephone conversation with another party. Headset 104 communicates with communicator 102 via a wireless connection 118, e.g., Bluetooth or another suitable wireless protocol, for security. Battery 116 is the power supply for headset 104 for the wireless transmission. Headset 104 may have additional UI (user interface) or control features for control of the system, here the cellphone. For example, headset 104 comprises one or more buttons for volume control, power on/off, etc., and has circuitry to provide audio (bleeps), or colored LEDs for, e.g., indicating the charge state of battery 116. Alternatively, these functionalities are managed on communicator 102 in order to keep headset 104 lean.

Bluetooth headsets typically give 3-5 hours talk time or 50-100 hours standby time from a 200 mAh battery. A more simple technology could feasibly divide the current needed by a factor of 2 to 3. That size battery weighs, say, 6-10 gram, the whole headset 25-30 gram. The module itself needs a supply rail of around 3V, so a 3.6V Li ion or NiMH battery is often being used. A design could use a 2.4V or 1.2V battery with a voltage doubler, as it may allow a cheaper or wider battery choice. For very low power applications, e.g., with low peak currents, a large capacitor may work as the power source. This is especially suitable for accessories needing only a current measured in mA. One of the large capacity memory back-up capacitors could work in place of a true battery. Typically, a cellphone achieves 300 hours standby or 3 hours talk time from a 1000 mAh battery. Reducing battery storage requirements allows a smaller or cheaper battery, and reduces weight and/or size. Fully charging a 200 mAh battery from a fully charged cellphone may only reduce the latter's power capacity by 20%.

PDA, laptops or other equipment in the user's PAN, could serve to charge the battery cache. In addition, other methods can be used to keep the cache topped up, solar cell, wind up piezo or clockwork generator like device, or a piezo charger attached to the person's shoe, etc. For example, the headset could use a solar cell to keep the headset's battery charged or to slow down its decharging rate. For very low power devices one could even consider rectifying the ambient 60 Hz power line fields induced into a loop woven into a belt or in the user's clothing.

FIG. 2 is a diagram of a data processing system 200 with a power caching architecture in the invention. System 200 comprises first, second and third components 202, 204 and 206. Components 202-206 can be used together to form a synergetic combination when in operation, either attached to each other or detached. The cellphone discussed above is an example of such a mobile system. Alternatively, or supplementarily, components 202-206 can perform separate functions without the need for cooperation with one of the others. An example hereof is the display monitor mentioned earlier. Another example is a laptop PC designed, and equipped with features, for docking other electronic components, e.g., for ease of transportation and for power caching as explained below. Components 202-206 each have a respective onboard power source 208, 210 and 212, respectively. Such power source comprises, e.g., a rechargeable battery or battery pack. Component 204 is designed for accommodating component 206 in such as way that the latter's power source 208 is charged or recharged from power source 210 of component 204. Similarly, Component 202 is designed to accommodate component 204 in such a way that power source 210 gets charged or recharged from power source 208. In this way a power caching hierarchy is implemented that enables the user to benefit from the battery power available in the PAN.

Herein incorporated by reference:

U.S. Ser. No. 09/919,661 (attorney docket U.S. 018114) filed Jul. 31, 2001 for Glenn Adler for DISPLAY MONITOR HAS STAND-ALONE MODE AND PC PERIPHERAL MODE. This document relates to a display monitor with at least a stand-alone operational mode, and a further operational mode as a further peripheral to, e.g., a PC. The monitor has an input for connecting to a first peripheral device. The monitor also has circuitry for enabling data communication with the first peripheral device for user control of a functionality of the display monitor in the stand-alone mode, and for data communication between the first peripheral and the PC via the monitor when the monitor is in the further operational mode and connected to the PC and to the first peripheral.

U.S. Ser. No. 09/464,855 (attorney docket PHA 23,875) filed Dec. 16, 1999 for Willem Bulthuis et al., for HAND-EAR USER INTERFACE FOR HAND-HELD DEVICE. This document relates to a hand-held information processing device, such as a mobile phone. The device has a thumb wheel that lets the user scan a circular array of options. Each respective one of the options is represented by a respective audio output that gets played out when the wheel is turned a notch up or down. This enables the user to select an option with one hand and without having to look at the device. It also allows for a form factor smaller than that of a conventional mobile phones since a keypad is not needed for entering digits to make a call from a personalized directory.

What is claimed is

1. A data processing system comprising:
a first component with a first power source; and
a second component with a second power source;
wherein:
the first power source serves as a charger of the second power source when the first and second components are attached to each other; and
the second power source powers the second component when detached from the first component.

2. The system of claim 1, wherein:
the first and second components implement a first system functionality when attached; and
the first and second components implement the first system functionality when detached.

3. The system of claim 1, wherein:
the first and second components implement a first system functionality when attached; and
at least the second component implements a second system functionality when detached from the first component.

4. The system of claim 1, wherein:
the system comprises a cell phone; and
the second component comprises a headset.

5. The system of claim 1, wherein:
the second component comprises a display monitor.

6. The system of claim 1, wherein the second power source is charged by the first power source in a contactless manner.

7. The data processing system of claim 1, forming part of a PAN.

8. The system of claim 1, wherein the first power source comprises a battery.

9. A mobile data processing system with first and second components having first and second power sources, respectively, and wherein the first power source charges the second power source when the components are detachably attached to each other.

10. A module for use in a data processing system, the system comprising a first component with a first power source; wherein:
the module comprises a second component with a second power source;
the first power source serves as a charger of the second power source when the first and second components are attached to each other; and
the second power source powers the second component when the module is detached from the first component.

11. The module of claim 10, wherein:
the system comprises a cellphone;
the second component comprises a headset.

12. The module of claim 10, wherein the system comprises a PC and wherein the second component comprises a display monitor.

13. The module of claim 10, having a solar cell.

14. The module of claim 10, comprising a UI for user-control of the system.
